(19) United States
(12) Patent Application Publication
(10) Pub. No.: US 2003/0026976 A1
(43) Pub. Date: Feb. 6, 2003

(54) Foamed adhesive and use thereof

(76) Inventors: Ronald J. Skrzyniarz, Easton, PA (US); Lisa Brown, Warren, NJ (US)

Correspondence Address: Cynthia L. Foulke, NATIONAL STARCH AND CHEMICAL COMPANY, 10 Finderne Avenue, Bridgewater, NJ, 08807-0500, US

(21) Appl. No.: 09/916,779

(22) Filed: Jul. 27, 2001

(51) Int. Cl. B32B 7/12; B32B 15/04

(52) U.S. Cl. 428/343; 428/354

(57) ABSTRACT

High pressure laminate can be bonded to a substrate material such as particle board using a foamed adhesive. Method finds particular usefulness in the manufacture of countertops.

### FIELD OF THE INVENTION

The invention relates to an article of manufacture prepared by bonding a high pressure laminate to a wood composite using a foamed adhesive.

### BACKGROUND OF THE INVENTION

Laminated products have largely replaced natural materials in the construction of furniture, cabinets, countertops and the like, due in large part to the strength, durability, decorativeness and cost of these products. Such products are typically prepared by bonding a surface material to a core material using an adhesive, and application of heat and pressure. Countertops, for example, are conventionally fabricated from particle board (core material) and a high pressure laminate (surface material) or like conventional counter material.

While liquid solvent-based adhesives and aqueous liquid adhesives have been used to bond materials to substrate materials, these adhesives have a number of disadvantages associated with their use. Solvent-based adhesives pose environmental and health hazards and are difficult to handle. Aqueous liquid adhesives require significant drying times, require long set or cure times, and the water contained within them tends to swell surface and/or core materials. It is known, for example, that countertops prepared with prior art adhesives are prone to warpage. This warpage is generally due to water in the bondline and heat from the oven.

A need thus exists for alternative methods of preparing laminated articles useful as countertops and the like. The current invention provides a method of preparing laminated articles, such as countertops, which is safe, effective and, in addition, provides substantial cost savings.

### SUMMARY OF THE INVENTION

The present invention relates to a foamed adhesive and to articles of manufacture comprising the foamed adhesive.

One aspect of the invention is directed to a foamed adhesive comprising at least one resin emulsion. In a preferred embodiment, the at least one resin emulsion comprises a polyvinyl acetate. Even more preferably, the at least one resin emulsion comprises a blend of two or more polyvinyl acetates. The adhesive preferably also comprises at least one filler. A preferred filler for use in the practice of the invention is a polysaccharide, most preferable a starch. The adhesive may, optionally, also comprise a surfactant.

Another aspect of the invention is directed to an article of manufacture comprising the foamed adhesive described herein. The article comprises a core material and a surface material, wherein the core material and surface material are bonded together with the foamed adhesive, preferably a foamed polyvinyl acetate emulsion-based adhesive. In a preferred embodiment, the substrate material is a wood composite and the surface material is a high pressure laminate. Articles of manufacture encompassed by the invention include countertops, architectural panels, flipper doors and the like.

Yet another aspect of the invention is directed to a method for bonding materials together which comprises applying the foamed adhesive composition of the invention to a first substrate, bringing a second substrate in contact with the adhesive composition applied to the first substrate, and subjecting the applied composition to conditions which will allow the composition to cool and form a set bond. In a preferred embodiment, at least one of said substrates comprises a wood composite material. In a particularly preferred embodiment, the one substrate is a wood composite and one substrate is a high pressure laminate.

### DETAILED DESCRIPTION OF THE INVENTION

It has now been discovered that emulsion-based adhesives in the foamed state, in particular polyvinyl acetate emulsion-based adhesives, may be used for bonding high pressure laminates to wood composites such as particle board. By foaming, less water is introduced into the construction, the temperature requirements of the top heaters may be decreased, and line speed may be increased. The foamed adhesive when used in the practice of the invention has sufficient wet bond strength for holding sheets of high pressure laminate (HPL) to sheets of particle board as these panels are moved through a heating and pressing zone.

The adhesives of the invention may be used to prepare various articles of manufacture, but are particularly useful in bonding high pressure laminates to particle board. Articles of manufacture that can be made in accordance with the invention include, but are not limited to, countertops, office partitions, architectural doors, flipper doors, and the like.

Countertops are universally found in a wide variety of work places and the term “countertop” is used herein in its broadest sense to include work surface areas found in offices, kitchens, laboratories, class rooms, and like places. While the discussion which follows will speak for convenience in terms of the manufacture of a countertop, the invention is not to be limited thereto. It is to be understood that any article manufactured using the adhesive of the invention to bond one substrate (e.g., a high pressure laminate) to another substrate (e.g., particle board) is encompassed by the invention.

The preparation of decorative, high pressure laminates is well known to those skilled in the art, and need not be described in detail herein. Laminates can be prepared from (1) a rigid substrate, (2) a melamine resin impregnated decorative sheet, and, in some cases (3) a melamine resin impregnated overlay sheet. In such decorative laminates, the rigid substrate may consist of any suitable material, such as particle board, a resin-binded wood fiberboard, a plurality of phenolic resin-impregnated sheet of e.g., Kraft paper, etc. The decor sheets are typically made of very heavy paper comprised of cellulose fibers and an opacifying pigment such as titanium oxide. The decor sheets are printed upon with designs to create the decorative pattern of the laminate. The overlay sheets are clear cellulose sheet which act as a protective layer over the decor sheet. The overlay sheets are used optionally depending on the need for protective surfaces.

These sheets are heated under high pressure to form a single component that can be incorporated into furniture, used on countertops or flooring, etc. In a typical process for preparing laminates, the sheets are saturated with the appropriate thermoset resins (e.g., melamine or phenolic resin). The amount of resin incorporated into these laminates typically varies from 30% to 80% based on the weight of the total laminate, and depends on the type of application and the type of materials used to make the laminate. After the paper is impregnated with the resin, it is dried to a suitable volatile content and the sheets are then assembled into a laminate between two pressing plates. The laminate is then formed in this fashion under a specific pressure (generally 1000-2000 psi) and temperature (generally from about 2500 to about 350° F.) for periods of 5 to 45 minutes. The laminate made in this manner must then pass several physical tests, including post-formability and resistance to boiling water.

The terms “wood composite” and “particle board” are used interchangeably through out this disclosure. These terms are meant to encompass chipbboard, particleboard, medium density fiberboard, high density fiberboard, oriented strandboard, hardboard, hardwood plywood, veneer core plywood, isocyanate or phenolic impregnated strawboard, and wood composites made from woodfiber and polymers, such as recycled polyethylene.

Preferred foamed adhesives comprise at least one resin emulsion, and may also comprise at least one filler. Typically, the foamed adhesive comprises more than about 30%, more typically from about 50% by weight to about 100% by weight of the resin emulsion, and from 0% by weight to about 50% by weight of filler. More preferred are foamed adhesives comprising from about 55% by weight to about 85% by weight of at the at least one polymer emulsion, and from about 5% by weight to about 20% by weight of a filler. Preferred are foamed adhesives comprising a blend of two or more polyvinyl acetate emulsions.

Resin emulsions which may be used in the practice of the invention are emulsions and mixtures having a high glass transition temperature (i.e., a Tg greater than about 10° C.). Polyvinyl acetate is a preferred for use in the practice of the invention. Mixtures of two or more polyvinyl acetates and mixtures of polyvinyl acetate and other polymer emulsions and monomers, including but not limited to ethylene vinyl acetate and acrylic monomers, are encompassed. Polyvinyl acetate may be prepared using a continuous or a batch process. Polyvinyl acetates emulsion mixtures wherein the polyvinyl acetates used are prepared by one method or by both methods may be used. Such polyvinyl acetates are commercially available from National Starch and Chemical, Bridgewater, N.J.

The adhesive preferably also contains a filler. The addition of a filler allows for foam generated to remain consistent and stable for several hours. Suitable fillers are those fillers known in the art as adhesives fillers and include polysaccarides, calcium carbonate, clay, mica, nut shell flours, silica, talc and wood flour. Most preferably the filler is a polysaccharide.

Polysaccharides useful in the invention include starch, dextrin, cellulose, gums or combinations thereof. Particularly useful are the starches and dextrins including native, converted or derivatized. Such starches include those derived from any plant source including maize (corn), potato, wheat, rice, sago, tapioca, waxy maize, sorghum and high amylose starch such as high amylose corn, i.e. starch having at least 45% amylose content by weight. Starch flours may also be used. Also included are the conversion products derived from any of the former bases, such as, for example, dextrins prepared by hydrolytic action of acid and/or heat; fluidity or thin boiling starches prepared by enzyme conversion or mild acid hydrolysis; oxidized starches prepared by treatment with oxidants such as sodium hypochlorite; and derivatized or modified starches such as cationic, anionic, amphoteric, non-ionic, crosslinked and hydroxypropyl starches. Other useful polysaccharides are cellulose materials such as carboxymethylcellulose, hydroxypropyl cellulose and hydroxypropyl methylcellulose, and gums such as guar, xanthan, pectin and carrageenan may also be used in the practice of the invention. Modified starches include, but are not limited to, those modified with an alkyl succinic anhydride. Preferred are octenyl succinic anhydride (OSA) and dodecenyl succinic anhydride (DDSA) modified starches or dextrins.

In addition to fillers, other additives typical of adhesive compositions may be added to the foamable composition. Said additives include, but are not limited to, plasticizers, acids, waxes, synthetic resins, tackifiers, defoamers, preservatives, bases such as sodium hydroxide, dyes, pigments, UV indicators, and other additives commonly used in the art.

The adhesive may also contain a surface-active agent. Examples of surface-active agents include anionic, cationic, amphoteric, or nonionic surfactants, or mixtures thereof. Suitable anionic surfactants include, alkyl sulfonates, alkylaryl sulfonates, alkyl sulfates, sulfates of hydroxylalkanols, alkyl and alkylaryl disulfonates, sulfonated fatty acids, sulfates and phosphates of polyethoxylated alkanols and alkylphenols, and esters of sulfosuccinic acid. Suitable cationic surfactants include, alkyl quaternary ammonium salts, and alkyl quaternary phosphonium salts. Suitable non-ionic surfactants include the addition products of 5 to 50 moles of ethylene oxide adducted to straight-chain and branched-chain alkanols having 6 to 22 carbon atoms, alkylphenols, higher fatty acids, higher fatty acid amines, primary or secondary higher alkyl amines, and block copolymers of propylene oxide with ethylene oxide, and mixtures thereof. When used, the surface active agent will typically be added in amounts up to about 20% by weight, based on the foamable composition as a whole. More usually from amounts of from about 0.05 to about 20% by weight, and preferably at from 0.2 to 2% by weight.

The foamable adhesive composition of the invention is foamed by the addition of energy, by means known in the art such as, but not limited to, by mechanical and/or chemical means. Air or other gases are added to the foamable adhesive composition along with the addition of said energy to produce a stable, consistent foamed adhesive. Preferably air is used to produce the foamed adhesive. The adhesive foam may be produced by mechanical means such as mechanical stirring or agitation, introduction of gases or by chemical means.

The amount of air dispersed in the adhesive can vary depending on the particular formulation, but will generally be from about 10% (by volume) up to about 50% (by volume) or greater.

The adhesive may be applied by any method known in the art. Typically the particle board is coated with from about 2½ to about 6 wet mils of foamed adhesive, most typically about 3 mils. Preferably, the foamed adhesive is applied using a roll coater, also referred to in the art as a glue spreader.

In a preferred method of this invention, pressure is applied in a continuous process at a temperature of less than about 170° F., most preferably about 120° F. to about 160° F., and even more preferably at a temperature of about 140° F. The pressure at which bonding takes place is generally greater than 20 psi (138 Kpa). Heat may be introducted by heating elements, or by heating rollers. Typical bonding pressure is no more than 300 psi, although higher pressure is possible. Pressure may be applied to the construction by any suitable means. Preferably, pressure is applied via a roller or by hot pressing. The most preferred method of applying pressure is via a nip roller.

The bonding temperatures that may be used in the practice of the invention are lower than prior art temperatures used when employing unfoamed adhesives and require less power usage in the process; reduced cycle time between successive laminate presses; saves on processing costs; improves productivity; and causes less drying of the wood, resulting in a higher quality final product. The method of this invention may be substantially automated for mass production techniques and utilizes a relatively small amount of foamed adhesive when compared with prior art methods.

The method of the present invention can be advantageously utilized in the manufacture of furniture laminates, cabinet door laminates, flooring laminates, residential and architectural door skin laminates, store fixtures, countertops, and the like.

The invention is further illustrated by the following non-limiting examples.

### EXAMPLES

In the Examples, the following tests were conducted as follows:

Tensile Strength

Tensile strength of the boards was determined by cutting a one square inch section in the laminate and pulling using a tensile tester (available from Instron and Syntec). Pull values of 75 lbs or greater are considered acceptable.

Fiber Tear

Adhesion levels of the surface overlay to the core substrate were determined by peeling back sections of surface overlay from the core substrate, by use of a metal spatula and/or knife blade, and evaluating the peeled surface of surface overlay. For good adhesion, the peeled surface overlay should show 100% coverage with adhesive and particles of the core substrate, indicating 100% cohesive failure in the substrate. The degree of adhesion was assessed by approximating the % of the peeled surface overlay which was covered with core substrate fibers or particles (that is, the % cohesive failure of the core substrate). For example, if 50% of the peeled surface overlay is covered by core substrate particles, then the failure is recorded as 50% cohesive failure in the core substrate. Delamination refers to cases where 0% of peeled surface overlay is covered by core substrate particles, indicating failure of the adhesive bond or clean peel of the adhesive from the core substrate.

### Example 1

An adhesive composition was prepared using 29.8% of a polyvinyl acetate prepared using batch polymerization process, 54.7% of a polyvinyl acetate prepared using a continuous polymerization process, 9.9% corn starch, 5.4% of a plastizer and 0.1% of a preservative. This adhesive was foamed to 40% using a Hansa foaming unit.

### Example 2

The adhesive having the formulation of Example 1, both prior to foaming and with a foam level set at 40%, was used to bond HPL to particle board. The HPL/particle board construct was prepared as follows.

Adhesive was fed manually to a coater (commercially available from Black Brothers and from Union Tool). The particle board was coated with approximately 4 to 6 wet mils of adhesive. The HPL was indexed manually onto the board. The construction next traveled down the conveyor to a heated roller press. Roller presses with a length of from 4 feet to 30 feet, having multiple nippers, usually from 2 to 20 nippers from inlet to outlet, and equipped with both top and bottom heaters are commercially available from Midwest Automation and from Evans. Typically the nippers will have a variable temperature profile ranging from about 110° to about 160° F. for top heat, with maximum temperature in the center. The bottom temperature of the core is typically maintained from between about 160° and 180° F.

Foamed adhesive was tested at three ovens temperatures dropped successively by 5% (on a percentage scale). Results are shown in Table 1. Pull value reported is the average of multiple tests.

TABLE 1

| | | 40% Foam | 40% Foam | 40% Foam |
|---|---|---|---|---|
| | Unfoamed | (5% decrease) | (10% decrease) | (15% decrease) |
| T₁, ° F. | 125 | 115 | 111 | 91 |
| T₂, ° F. | 137 | 125 | 122 | 103 |
| T₃, ° F. | 146 | 123 | 115 | 100 |
| T₄, ° F. | 155 | 133 | 125 | 104 |
| T₅, ° F. | 148 | 135 | 121 | 101 |
| T_{outfeed}, | 117 | 116 | 105 | 95 |
| ° F. | | | | |
| T_{bottom}, | 125 | 118 | 110 | 103 |
| ° F. | | | | |
| Line | 19 | 19 | 19 | 19 |
| speed, | | | | |
| ft/min | | | | |
| Pull, psi | 79 | 72 | 92 | 68 |
| Fiber Tear | Medium | Medium | High | High |

When the ovens were dropped by 5%, the temperature profile dropped slightly, but the pull values remained high with medium fiber tear. When the ovens were decreased a second 5%, a lower temperature profile with high pull values and fiber tear resulted. After dropping the ovens another 5%, the temperature profile decreased again, but the bonds maintained respectable pull values and wood tear.

By decreasing the amount of water in the bondline, oven temperatures can be decreased, lowering cost and decreasing the potential for warpage of the product. Moreover, since the boards can be run at lower oven temperatures, use of thinner HPL is possible.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A foamed adhesive comprising at least one resin emulsion.

2. The foamed adhesive of claim 1 where the adhesive is foamed from about 20 to about 60% weight per volume.

3. The foamed adhesive of claim 1 wherein the at least one resin emulsion is a polyvinyl acetate emulsion.

4. The foamed adhesive of claim 3 comprising a blend of at least two polyvinyl acetates.

5. The foamed adhesive of claim 4 wherein at least one polyvinyl acetate is prepared by batch polymerization and at least one polyvinyl acetate is prepared by continuous polymerization.

6. The foamed adhesive of claim 3 further comprising a filler.

7. The foamed adhesive of claim 6 wherein the filler is a polysaccharide.

8. The foamed adhesive of claim 7 wherein the polysaccharide is a starch.

9. The foamed adhesive of claim 1 comprising from about 55 to about 85% of said at least one resin emulsion and from about 5 to about 20% of a filler.

10. The foamed adhesive of claim 9 further comprising a surface active agent, a defoamer, a preservative or a UV indicator.

11. An article of manufacture comprising the foamed adhesive of claim 1.

12. The article of claim 11 which comprises a wood composite and a high pressure laminate, wherein the wood composite is bonded to the high pressure laminate using said foamed adhesive.

13. The article of claim 1 where the adhesive is foamed from about 20 to about 60% weight per volume.

14. The article of claim 11 wherein the adhesive comprises at least one polyvinyl acetate.

15. The article of claim 14 wherein the foamed adhesive further comprises a polysaccharide filler.

16. The article of claim 15 wherein the polysaccharide is a starch.

17. The article of 16 wherein the adhesive further comprising a surface active agent, a defoamer, a preservative or a UV indicator.

18. The article of claim 17 which is a countertop.

19. A method for bonding materials together which comprises applying the foamed adhesive composition of claim 1 to a first substrate, bringing a second substrate in contact with the adhesive composition applied to the first substrate, and subjecting the applied composition to conditions which will allow the composition to cool and form a set bond, wherein one of said first or second substrate is a wood composite and the other of said first or second substrate is a high pressure laminate.

20. The method of claim 11 wherein said conditions which will allow the composition to cool and form a set bond comprises heat and pressure.
